(19) United States
(12) Patent Application Publication
(10) Pub. No.: US 2026/0269554 A1
(43) Pub. Date: Sep. 10, 2026

(54) COMPRESSION-REFRIGERATION FIBER LASER

(71) Applicant: GW (SHANGHAI) LASER TECHNOLOGY CO., LTD., Shanghai (CN)

(72) Inventors: Xianming ZHANG, Shanghai (CN); Jinhui LIU, Shanghai (CN); Jianwu DING, Shanghai (CN)

(73) Assignee: GW (SHANGHAI) LASER TECHNOLOGY CO., LTD., Shanghai (CN)

(21) Appl. No.: 18/721,663

(22) PCT Filed: Dec. 10, 2022
(86) PCT No.: PCT/CN2022/138227

§ 371 Date: Jun. 19, 2024

(30) Foreign Application Priority Data
Dec. 19, 2021 (CN) 202111586037.3

(51) Int. Cl. H01S 3/042; H01S 3/04; H01S 3/067; H01S 3/094

(52) U.S. Cl. CPC H01S 3/042; H01S 3/0404; H01S 3/0405; H01S 3/0407; H01S 3/06704; H01S 3/094003

(57) ABSTRACT

A compression refrigeration fiber laser comprises a housing, an optical portion, a compression refrigeration device, and a photoelectric interface portion. Structures and relative positions of the fiber laser and the compression refrigeration device in the laser housing are reasonably constructed, so that heat of the laser is quickly transferred out without affecting the stability of the laser.

### TECHNICAL FIELD

The present invention relates to a compression refrigeration fiber laser, which uses compression refrigeration to control the temperature of a pump light source in a machine case.

### BACKGROUND ART

The process of using high-power laser is highly dependent on the refrigeration mechanism. In conventional laser refrigeration, water cooling mechanism is mostly adopted for refrigeration, which is huge and has strict installation conditions, which is not conducive to outdoor portable welding.

At present, some lasers adopt air cooling mechanism for heat dissipation, most of which directly use a fan to dissipate heat of a heat source or a heat dissipator under a heat sink, for example, as disclosed by CN212114287U, since the optical device is relatively precise, the air channel directly flows through the side of the optical device or near the optical device side, which easily affects the optical device, causes a decrease in some indexes and affects the reliability of the device. In the prior art, an air-cooled heat dissipation fiber laser using compression refrigeration, such as CN103279149A, discloses a structure adopting a refrigeration and heating cycle of a compressor to keep the laser at a constant temperature, and document CN203071389U discloses a small laser device adopting frequency conversion compression refrigeration, but they all merely adopted the principle of simple frequency conversion compression, the structure is not optimized according to the characteristics of the fiber laser and the principle of compression refrigeration, and the structure of the refrigeration system is complex and illogical with poor heat removal capability, which affects the refrigeration capability of the whole system, has small output power and poor air channel isolation effect, and affects the stability of the device.

### SUMMARY OF THE INVENTION

In view of the deficiencies of the prior art, the present invention provides a compression refrigeration fiber laser, which overcomes the defects in the prior art and is reasonable in design.

To achieve the above objective, the present invention is achieved by the following technical solutions:

A compression refrigeration fiber laser of the present invention comprises a main part of the laser, the main part of the laser comprises a laser housing, an optical portion of the fiber laser, a laser refrigeration device, a laser drive portion and a photoelectric interface portion are arranged in the housing.

The optical portion is arranged for emitting an optical fiber laser signal, which comprises a pump laser unit, a gain fiber portion, a temperature control plate and an optical portion driving device, and preferably further comprises an N+1 forward and reverse optical fiber combiner.

The pump laser unit comprises more than one semiconductor laser, preferably, the semiconductor laser is arranged to provide a 976 nm pump laser that is absorbed by the gain chamber within a certain temperature range.

The gain optical fiber portion preferably comprises a ytterbium-doped gain optical fiber and a first grating and a second grating at both ends of the ytterbium-doped gain optical fiber.

The temperature control plate is a cold plate, the semiconductor laser and/or the gain optical fiber portion are/is arranged on the cold plate, the cold plate is a buried pipe cold plate, and can be a single-sided buried (copper) pipe cold plate or a double-sided buried (copper) pipe cold plate (the cold plate plays a role of an evaporator in the refrigeration process).

The N+1 forward and reverse optical fiber combiner is arranged for combining and coupling pump light emitted by the pump laser unit into the gain optical fiber portion.

Preferably, the pump laser unit, the gain optical fiber portion, and the N+1 forward and reverse optical fiber combiner of the optical portion are all integrated and arranged on the cold plate of the temperature control plate, the cold plate is a flat planar structure, and a cold plate refrigerant (copper) pipe is buried in the cold plate. The laser refrigeration device comprises a (frequency conversion) compressor, a condenser, at least one refrigerant pipeline, an expansion valve, and (frequency conversion) fans (which may further comprise an electromagnetic four-way reversing valve and a refrigerant liquid storage tank), and the laser refrigeration device is a phase-change frequency conversion compression temperature control system arranged to provide temperature cooling with a large temperature difference for the semiconductor laser; wherein the at least one cold plate refrigerant pipeline is connected with the at least one refrigerant pipeline of the laser refrigeration device, and is arranged for circulation and cycling of refrigerate, a frequency conversion compressor is connected with the condenser and the at least one cold plate refrigerant pipeline through at least one refrigerant pipeline, refrigerate is arranged in the at least one refrigerant pipeline and the at least one cold plate refrigerant pipeline.

Preferably, the laser refrigeration device further comprises a drying filter, wherein the drying filter is arranged between the condenser and a thermal expansion valve. Preferably, an aluminum parallel flow heat exchanger is adopted for the condenser.

The laser drive portion is arranged for driving the laser refrigeration device and the optical portion.

The photoelectric interface portion is arranged for connection between a main part of the laser and external photoelectricity, comprising a device power input port, a safety lock interface, a control signal input interface, an output optical cable interface, and the like.

The device power input port is arranged for external power supply; the safety lock interface is arranged for safe interlocking of laser; and the control signal input interface is arranged for inputting an external control signal.

The housing is an approximate rectangular housing, and is enclosed by a front cabinet plate, a rear cabinet plate, an upper cabinet plate, a lower cabinet plate, a left cabinet plate and a right cabinet plate.

The housing comprises an upper cabinet plate and a lower cabinet plate corresponding thereto, four side plates are comprised between the upper cabinet plate and the lower cabinet plate, and the four side plates are respectively a first side plate (namely a left cabinet plate), a second side plate (namely a front cabinet plate), a third side plate (namely a right cabinet plate), and a fourth side plate (namely a rear cabinet plate) that are sequentially connected; the first side plate is opposite to the third side plate (namely, the left cabinet plate is opposite to the right cabinet plate), and the second side plate is opposite to the fourth side plate (namely, the front cabinet plate is opposite to the rear cabinet plate).

Wherein, an area of the first side plate is larger than that of the second side plate, and the area of the first side plate is larger than that of the fourth side plate; an area of the third side plate is larger than that of the second side plate, and the area of the third side plate is larger than that of the fourth side plate.

Wherein, a first ventilation hole and a second ventilation hole are respectively arranged on the upper cabinet plate of the housing and the lower cabinet plate of the housing, and a bottom-up circulation channel of air is formed between the two ventilation holes. Preferably, a first fan group is arranged on a lower side of the upper cabinet plate, a second fan group is arranged on an upper side of the lower cabinet plate, alternatively, only the first fan group of the upper cabinet plate or the second fan group of the lower cabinet plate may be provided. Since the air rises after being heated, in order to prevent the turbulence of the airflow and the outflow of the acceleration heat, wherein rotation directions of fans are set to accelerate air flow from the ventilation holes in a lower portion of the laser housing and then flowing out from the ventilation holes in a upper portion of the laser housing.

The cold plate is a flat planar structure, which has a first cold plate surface on which a semiconductor laser is arranged and a second cold plate surface opposite to the first cold plate surface, the cold plate is vertically arranged on one side in the laser housing.

The housing has an interior space (namely a space enclosed by six plates of the housing) between the upper cabinet plate and the lower cabinet plate, and the interior space is divided into a first interior space close to the first side plate and a second interior space close to the third side plate.

The first ventilation hole is arranged on a portion of the upper cabinet plate corresponding to the second interior space, and the second ventilation hole is arranged on a portion of the lower cabinet plate corresponding to the second interior space.

Wherein, the optical portion comprising the cold plate is arranged in the first interior space, the cold plate is substantially parallel to the first side plate (namely the left cabinet plate), a second cold plate surface of the cold plate faces an inner side of the first side plate (namely the left cabinet plate) of the housing. The second cold plate surface of the cold plate faces the third side plate of the housing, and the second cold plate surface of the cold plate serves as a boundary surface of the first interior space and the second interior space.

Four lateral sides of the cold plate are respectively in contact with the upper cabinet plate, the lower cabinet plate, the second side plate and the fourth side plate of the housing, the cold plate and the housing jointly enclose the sealable first interior space, a complete separation surface of the first interior space and the second interior space is formed on the second cold plate surface of the cold plate, which completely separate the first interior space and the second interior space, such that air flowing between the first ventilation hole and the second ventilation hole does not pass through the first interior space, which prevent the optical portion from being affected.

On a side (the second cold plate surface) of the cold plate facing the second space, a convex structure of the cooling fin of the cold plate can be preferably arranged. Preferably, the convex structure of the cooling fin of the cold plate comprises a plurality of fin protrusions extending in a vertical direction, and a vertical groove extending in a vertical direction is formed between the plurality of fin protrusions.

The laser refrigeration device is arranged in the second interior space, namely, the compressor, the condenser, the at least one refrigerant pipeline, the expansion valve, the fans (further comprising the electromagnetic four-way reversing valve and a refrigerant liquid storage tank in some embodiments) are provided in the second interior space; wherein the condenser is arranged on an upper side of the second interior space (which facilitates taking away the heat), the condenser comprises a condensation fin device with the at least one refrigerant pipeline buried therein, and the condensation fin device is arranged between a compressor device and the first ventilation hole.

The condensation fin device is arranged on a lower side of the first ventilation hole of the upper cabinet plate, the condensation fin device has multiple gaps between fins, and the multiple gaps form a bottom-up air channel, so that the circulation channel of the air is not shielded by the condensation fin device.

The first ventilation hole is arranged on the upper side of the second interior space, and the second ventilation hole is arranged on a lower side of the second interior space.

Preferably, a first fan group is arranged on a lower side of the condensation fin group and an upper side of the compressor, namely, arranged between the condensation fin group and the compressor; certainly, the first fan group can also be arranged on a lower side of the first ventilation hole and an upper side of the condensation fin group, namely, arranged between the first ventilation hole and the condensation device, so that the airflow in the channel is more stable.

Preferably, a second fan group is arranged between the compressor and the second ventilation hole.

The second side plate of the housing has a photoelectric interface installation area close to the first side plate and a heat dissipation surface area close to the third side plate; the photoelectric interface installation area is arranged for installing at least part or all of the interfaces of the photoelectric interface portion.

The photoelectric interface installation area of the second side plate corresponds to a side of the first interior space, and since the first interior space has an optical component such as a pump light source and a gain optical fiber, the photoelectric interface is arranged in the photoelectric interface installation area close to the first side plate, so as to be directly connected with an optical device arranged in the first interior space, which avoids longer and complicated photoelectric wiring inside.

The heat dissipation surface area of the second side plate corresponds to a side of the second interior space, and since a refrigeration device is arranged in the second interior space and the air cooling channel is formed, a surface structure for enhancing heat dissipation is arranged in the heat dissipation surface area of the second side plate, which enhances the heat dissipation of the device. A plurality of heat dissipation protrusions are provided on the heat dissipation surface area, and preferably, the heat dissipation protrusions may be provided on a side of the heat dissipation surface area facing the outside of the housing and/or toward a side in the housing.

Similarly, preferably, the fourth side plate of the housing may also be arranged as that of the second side plate.

The fourth side plate of the housing has a photoelectric interface installation area close to the first side plate and a heat dissipation surface area close to the third side plate; and the photoelectric interface installation area is arranged for installing at least part or all of the interfaces of the photoelectric interface portion.

The photoelectric interface installation area of the fourth side plate corresponds to a side of the first interior space, and since the first interior space has an optical component such as a pump light source and a gain optical fiber, the photoelectric interface is arranged in the photoelectric interface installation area close to the first side plate, so as to be directly connected with an optical device arranged in the first interior space, which avoids longer and complicated photoelectric wiring inside.

The heat dissipation surface area of the second side plate corresponds to a side of the second interior space, and since a refrigeration device is arranged in the second interior space and the air cooling channel is formed, a surface structure for enhancing heat dissipation is arranged in the heat dissipation surface area of the fourth side plate, which enhances the heat dissipation of the device. A plurality of heat dissipation protrusions are provided on the heat dissipation surface area, and preferably, the heat dissipation protrusions may be provided on a side of the heat dissipation surface area facing the outside of the housing and/or toward a side in the housing.

In some embodiments, a surface of the third side plate of the housing facing the outside of the housing and/or a surface facing the interior of the housing has a convex structure for enhancing heat dissipation.

Preferably, a size of the cabinet body is 650 mm×300 mm×570 mm. Preferably, universal wheels are respectively arranged at four corners of the lower cabinet plate of the cabinet body. An aluminum profile structure is adopted for the housing, which is convenient to assemble, disassemble and maintain, and also saves cabinet space while ensuring heat dissipation. Preferably, the compression refrigeration fiber laser is used for a portable handheld fiber welder.

### Beneficial Effects

The present invention provides a compression refrigeration fiber laser, which reasonably constructs the structure of the fiber laser and the compression refrigeration device, so that the heat of the laser is rapidly dissipated and the stability of the laser is not affected.

By integrating the pump light source, the combiner and the gain optical fiber of the fiber laser onto the cold plate, the laser is more integrated and convenient to cool, the pump laser is distributed on the large-area cold plate, as such the heat transfer is faster; the cold plate is laterally arranged on a side of the laser housing, and the refrigeration device is arranged on the other side in the housing, the heat is rapidly transferred away through the refrigerate in the pipeline in the buried pipe cold plate, and then the heat is brought to the condenser through the action of the compressor; by constructing an bottom-up air channel, the air is heated to rise naturally, and at the same time, the fans are set to accelerate the air to blown out from bottom to top, which facilitates the air blown by the heat via the fans; the first interior space for mounting the optical portion and the second interior space for refrigeration are separated by the cold plate to divide the space of the optical device and the heat dissipation space, which allows the condensation device to dissipate heat rapidly without affecting the laser; meanwhile, the air flows through the second cold plate surface of the cold plate, the second cold plate of the cold plate surface can also dissipate heat, which increases the surface area of heat dissipation; namely, under the same air channel, the heat is simultaneously transferred away by the same high-speed air flow from the heat conduction and heat dissipation structure adopting the refrigerant and the heat dissipation area on the second cold plate surface, and the double efficient heat dissipation (the condensation fin set on the forward path of the air channel and the heat conduction and heat dissipation on the second cold plate surface on the side of the air channel) does not complicate the layout in the machine case (the whole large air volume air channel is higher in efficiency and lower in noise than the plurality of discrete air channels); meanwhile, the interface installation area and the heat dissipation area are divided on the second side or the fourth side of the housing, which increases the heat dissipation capability of the housing and enables the photoelectric connection more direct at the same time, and reduces the complexity and possible optical attenuation of the photoelectric connection.

### DESCRIPTION OF DRAWINGS

Hereinafter, in order to more clearly illustrate the technical solutions in the present invention or the prior art, the accompanying drawings required in the description of the prior art will be briefly described.

FIG. 1 is a schematic diagram of a laser of the present invention;

FIG. 2 is a schematic diagram of an in-housing layout viewed from an outside of the housing to a fourth side plate (or a second side plate);

FIG. 3 is a schematic diagram of an air channel of the laser of the present invention;

FIG. 4 is a schematic diagram of the second side plate (or the fourth side plate) of the present invention;

FIG. 5 is an enlarged schematic diagram of a cold plate in FIG. 2;

FIG. 6 is a schematic diagram of showing a connection method of at least one refrigerant pipeline in FIG. 2;

FIG. 7 is a schematic diagram of a layout view from an upper side (or a lower side) of the housing;

FIG. 8 is a schematic diagram of a heat dissipation structure of a second cold plate surface of the cold plate.

### EMBODIMENTS

Hereinafter, in order to make the purpose, technical solutions and advantages of the present invention more clear, the technical solutions of the present invention will be clearly and completely described in conjunction with the accompanying drawings of the present invention.

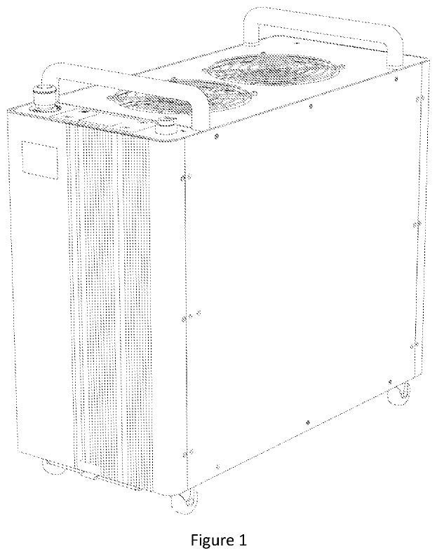

As shown in FIG. 1, a compression refrigeration fiber laser of the present invention comprises a main part of the laser, the main part of the laser comprises a laser housing, an optical portion of the fiber laser, a laser refrigeration device, a laser drive portion and a photoelectric interface portion are arranged in the housing.

The optical portion is arranged for emitting an optical fiber laser signal, which comprises a pump laser unit 101, a gain fiber portion 102, a temperature control plate 103 and an optical portion driving device, and preferably further comprises an N+1 forward and reverse optical fiber combiner.

The pump laser unit 101 comprises more than one semiconductor laser. In some embodiments, the semiconductor laser is arranged to provide a 976 nm pump laser that is absorbed by the gain chamber within a certain temperature range.

The gain optical fiber portion 102 preferably comprises a ytterbium-doped gain optical fiber and a first grating and a second grating at both ends of the ytterbium-doped gain optical fiber.

The temperature control plate 103 is a cold plate, the semiconductor laser and/or the gain optical fiber portion are/is arranged on the cold plate, the cold plate is a buried pipe cold plate, and can be a single-sided buried (copper) pipe cold plate or a double-sided buried (copper) pipe cold plate (the cold plate plays a role of an evaporator in the refrigeration process).

The N+1 forward and reverse optical fiber combiner is arranged for combining and coupling pump light emitted by the pump laser unit 101 into the gain optical fiber portion.

In some embodiments, the pump laser unit 101, the gain optical fiber portion 102, and the N+1 forward and reverse optical fiber combiner of the optical portion are all integrated and arranged on the cold plate of the temperature control plate 103, the cold plate is a flat planar structure, and a cold plate refrigerant (copper) pipe 1031 is buried in the cold plate.

The laser refrigeration device comprises a (frequency conversion) compressor, a condenser, at least one refrigerant pipeline, an expansion valve, and (frequency conversion) fans (which may further comprise an electromagnetic four-way reversing valve and a refrigerant liquid storage tank), and the laser refrigeration device is a phase-change frequency conversion compression temperature control system arranged to provide temperature cooling with a large temperature difference for the semiconductor laser; wherein the at least one cold plate refrigerant pipeline 1031 is connected with the at least one refrigerant pipeline of the laser refrigeration device, and is arranged for circulation and cycling of refrigerate, a frequency conversion compressor is connected with the condenser and the at least one cold plate refrigerant pipeline 1031 through at least one refrigerant pipeline, refrigerate is arranged in the at least one refrigerant pipeline and the at least one cold plate refrigerant pipeline 1031.

In some embodiments, the laser refrigeration device further comprises a drying filter, wherein the drying filter is arranged between the condenser and a thermal expansion valve.

In some embodiments, an aluminum parallel flow heat exchanger is adopted for the condenser.

The laser drive portion is arranged for driving the laser refrigeration device and the optical portion.

The photoelectric interface portion is arranged for connection between a main part of the laser and external photoelectricity, comprising a device power input port 4, a safety lock interface 5, a control signal input interface 6, an output optical cable interface 7, and the like.

The device power input port 4 is arranged for external power supply; the safety lock interface 5 is arranged for safe interlocking of laser; and the control signal input interface 6 is arranged for inputting an external control signal.

Referring to FIG. 1, the housing is an approximate rectangular housing, and is enclosed by a front cabinet plate, a rear cabinet plate, an upper cabinet plate, a lower cabinet plate, a left cabinet plate and a right cabinet plate.

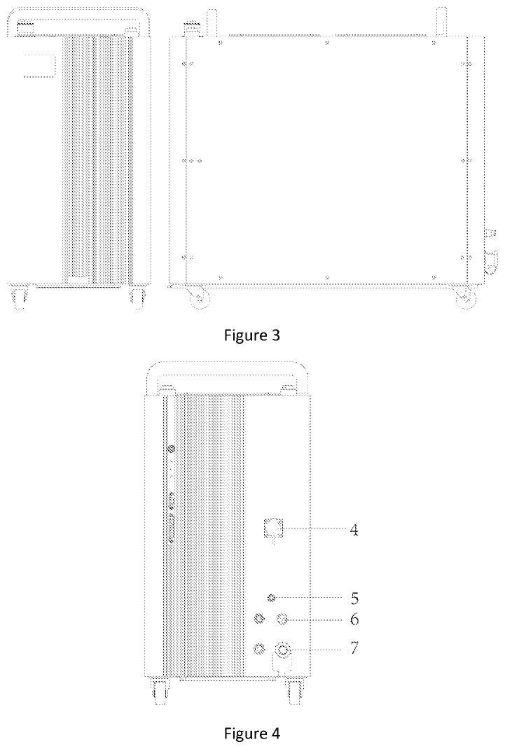

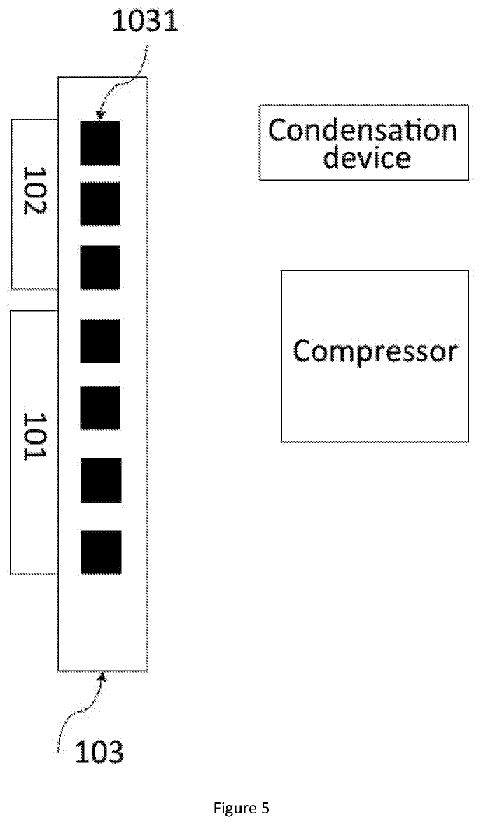

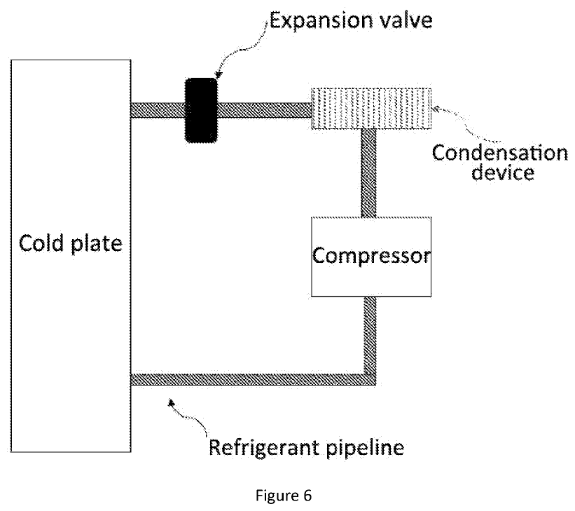

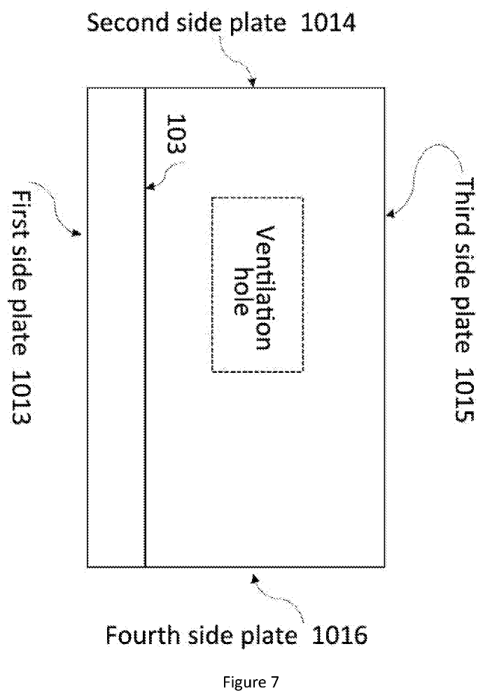

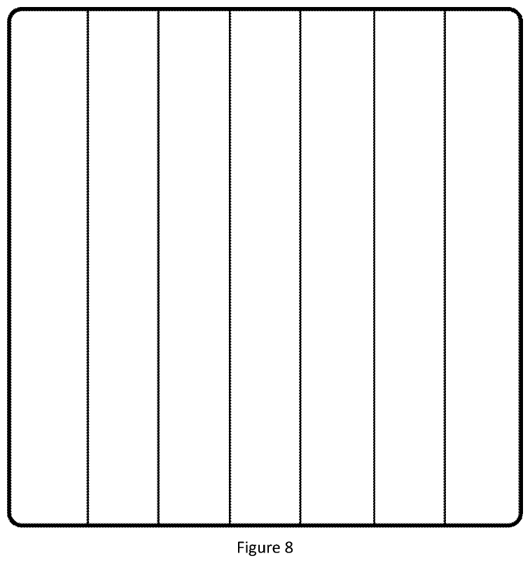

The housing comprises an upper cabinet plate 1011 and a lower cabinet plate 1012 corresponding thereto, four side plates are comprised between the upper cabinet plate and the lower cabinet plate, and the four side plates are respectively a first side plate 1013 (namely a left cabinet plate), a second side plate 1014 (namely a front cabinet plate), a third side plate 1015 (namely a right cabinet plate), and a fourth side plate 1016 (namely a rear cabinet plate) that are sequentially connected; the first side plate 1013 is opposite to the third side plate 1015 (namely, the left cabinet plate is opposite to the right cabinet plate), and the second side plate 1014 is opposite to the fourth side plate 1016 (namely, the front cabinet plate is opposite to the rear cabinet plate).

Wherein, an area of the first side plate is larger than that of the second side plate, and the area of the first side plate is larger than that of the fourth side plate; an area of the third side plate is larger than that of the second side plate, and the area of the third side plate is larger than that of the fourth side plate.

Wherein, a first ventilation hole and a second ventilation hole are respectively arranged on the upper cabinet plate 1011 of the housing and the lower cabinet plate 1012 of the housing, and a bottom-up circulation channel of air is formed between the two ventilation holes. In some embodiments, a first fan group is arranged on a lower side of the upper cabinet plate 1011, a second fan group is arranged on an upper side of the lower cabinet plate 1012, alternatively, only the first fan group of the upper cabinet plate or the second fan group of the lower cabinet plate may be provided. Since the air rises after being heated, in order to prevent the turbulence of the airflow and the outflow of the acceleration heat, referring to FIG. 3, rotation directions of fans are set to accelerate air flow from the ventilation holes in a lower portion of the laser housing and then flowing out from the ventilation holes in a upper portion of the laser housing.

The cold plate is a flat planar structure, which has a first cold plate surface on which a semiconductor laser is arranged and a second cold plate surface opposite to the first cold plate surface, the cold plate is vertically arranged on one side in the laser housing.

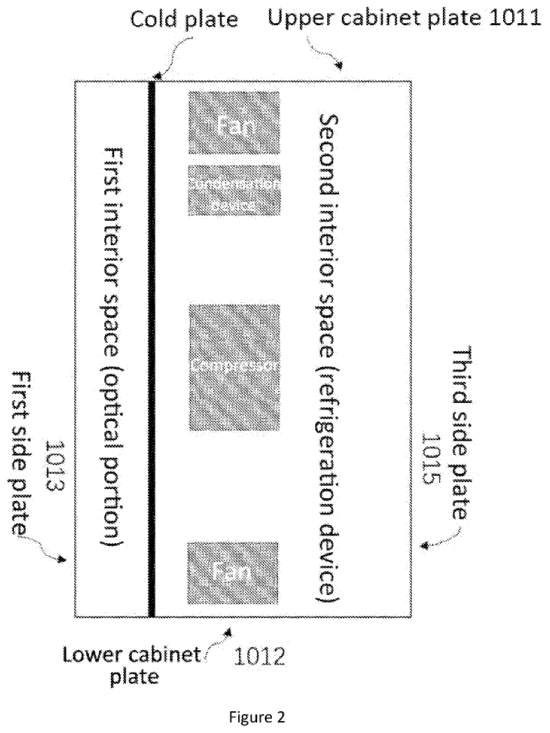

Referring to FIG. 2, the housing has an interior space (namely a space enclosed by six plates of the housing) between the upper cabinet plate 1011 and the lower cabinet plate 1012, and the interior space is divided into a first interior space close to the first side plate 1013 and a second interior space close to the third side plate.

The first ventilation hole is arranged on a portion of the upper cabinet plate corresponding to the second interior space, and the second ventilation hole is arranged on a portion of the lower cabinet plate corresponding to the second interior space.

Wherein, the optical portion comprising the cold plate is arranged in the first interior space, the cold plate is substantially parallel to the first side plate (namely the left cabinet plate), a second cold plate surface of the cold plate faces an inner side of the first side plate (namely the left cabinet plate) of the housing. The second cold plate surface of the cold plate faces the third side plate of the housing, and the second cold plate surface of the cold plate serves as a boundary surface of the first interior space and the second interior space.

Four lateral sides of the cold plate are respectively in contact with the upper cabinet plate, the lower cabinet plate, the second side plate and the fourth side plate of the housing, the cold plate and the housing jointly enclose the sealable first interior space, a complete separation surface of the first interior space and the second interior space is formed on the second cold plate surface of the cold plate, which completely separate the first interior space and the second interior space, such that air flowing between the first ventilation hole and the second ventilation hole does not pass through the first interior space, which prevent the optical portion from being affected.

The air flow passes through the second cold plate surface of the cold plate, and the second cold plate surface of the cold plate may also dissipate heat, which also increases the surface area of heat dissipation.

On a side (the second cold plate surface) of the cold plate facing the second space, a convex structure of the cooling fin of the cold plate can be preferably arranged, so that the heat of the cold plate is transferred away by high-speed air flow in addition to being transferred away by the refrigerate. Preferably, the convex structure of the cooling fin of the cold plate comprises a plurality of fin protrusions extending in a vertical direction, and a vertical groove extending in a vertical direction is formed between the plurality of fin protrusions, which increases the heat dissipation efficiency of air cooling.

The cold plate and the convex structure of the cooling fin of the cold plate are preferably an integrated structure, and preferably, the cold plate and/or the convex structure of the cooling fin of the cold plate is made of a highly thermally conductive material.

The laser refrigeration device is arranged in the second interior space, namely, the compressor, the condenser, the at least one refrigerant pipeline, the expansion valve, the fans (further comprising the electromagnetic four-way reversing valve and a refrigerant liquid storage tank in some embodiments) are provided in the second interior space; wherein the condenser is arranged on an upper side of the second interior space (which facilitates taking away the heat), the condenser comprises a condensation fin device with the at least one refrigerant pipeline buried therein, and the condensation fin device is arranged between a compressor device and the first ventilation hole.

The condensation fin device is arranged on a lower side of the first ventilation hole of the upper cabinet plate 1011, the condensation fin device has multiple gaps between fins, and the multiple gaps form a bottom-up air channel, so that the circulation channel of the air is not shielded by the condensation fin device.

In some embodiments, a volume of the second interior space is greater than a volume of the first interior space.

The first ventilation hole is arranged on the upper side of the second interior space, and the second ventilation hole is arranged on a lower side of the second interior space.

In some embodiments, a first fan group is arranged on a lower side of the condensation fin group and an upper side of the compressor, namely, arranged between the condensation fin group and the compressor; certainly, the first fan group can also be arranged on a lower side of the first ventilation hole and an upper side of the condensation fin group, namely, arranged between the first ventilation hole and the condensation device, so that the airflow in the channel is more stable.

In some embodiments, a second fan group is arranged between the compressor and the second ventilation hole.

Referring to FIG. 4, the second side plate 1014 of the housing has a photoelectric interface installation area close to the first side plate and a heat dissipation surface area close to the third side plate; the photoelectric interface installation area is arranged for installing at least part or all of the interfaces of the photoelectric interface portion.

The photoelectric interface installation area of the second side plate corresponds to a side of the first interior space, and since the first interior space has an optical component such as a pump light source and a gain optical fiber, the photoelectric interface is arranged in the photoelectric interface installation area close to the first side plate, so as to be directly connected with an optical device arranged in the first interior space, which avoids longer and complicated photoelectric wiring inside.

The heat dissipation surface area of the second side plate corresponds to a side of the second interior space, and since a refrigeration device is arranged in the second interior space and the air cooling channel is formed, a surface structure for enhancing heat dissipation is arranged in the heat dissipation surface area of the second side plate, which enhances the heat dissipation of the device. Referring to FIG. 4, a plurality of heat dissipation protrusions are provided on the heat dissipation surface area, and in some embodiments, the heat dissipation protrusions may be provided on a side of the heat dissipation surface area facing the outside of the housing and/or toward a side in the housing.

Similarly, in some embodiments, the fourth side plate 1016 of the housing may also be arranged as that of the second side plate 1014.

For example, the fourth side plate 1016 of the housing has a photoelectric interface installation area close to the first side plate and a heat dissipation surface area close to the third side plate; and the photoelectric interface installation area is arranged for installing at least part or all of the interfaces of the photoelectric interface portion.

The photoelectric interface installation area of the fourth side plate corresponds to a side of the first interior space, and since the first interior space has an optical component such as a pump light source and a gain optical fiber, the photoelectric interface is arranged in the photoelectric interface installation area close to the first side plate, so as to be directly connected with an optical device arranged in the first interior space, which avoids longer and complicated photoelectric wiring inside.

The heat dissipation surface area of the second side plate corresponds to a side of the second interior space, and since a refrigeration device is arranged in the second interior space and the air cooling channel is formed, a surface structure for enhancing heat dissipation is arranged in the heat dissipation surface area of the fourth side plate, which enhances the heat dissipation of the device. A plurality of heat dissipation protrusions are provided on the heat dissipation surface area, and in some embodiments, the heat dissipation protrusions may be provided on a side of the heat dissipation surface area facing the outside of the housing and/or toward a side in the housing.

In some embodiments, a surface of the third side plate of the housing facing the outside of the housing and/or a surface facing the interior of the housing has a convex structure for enhancing heat dissipation.

In one preferred embodiment, a size of the cabinet body is 650 mm×300 mm×570 mm.

In one preferred embodiment, universal wheels are respectively arranged at four corners of the lower cabinet plate of the cabinet body. An aluminum profile structure is adopted for the housing, which is convenient to assemble, disassemble and maintain, and also saves cabinet space while ensuring heat dissipation.

The above embodiments are only for illustrating the technical solutions of the present invention, rather than to limit the same; Although the present invention has been described in detail with reference to the aforementioned embodiments, those skilled in the art should understand that the technical solutions described in the aforementioned embodiments may still be modified, or some of the technical features may be replaced by equivalents; However, these modifications or replacements do not deviate the essence of the corresponding technical solutions from the spirit and scope of the technical solutions of the embodiments of the present invention.

1. A compression refrigeration fiber laser, comprising a housing, wherein an optical portion of the fiber laser and a laser refrigeration device are arranged in the housing, wherein the optical portion comprises a cold plate, and a pump laser and a gain optical fiber portion arranged on the cold plate; the laser refrigeration device comprises a compressor, a condenser, at least one refrigerant pipeline, an expansion valve and fans; wherein a first interior space and a second interior space are internally arranged in the housing, the optical portion is arranged in the first interior space, the laser refrigeration device is arranged in the second interior space; and the cold plate comprises at least one cold plate refrigerant pipeline, and the at least one cold plate refrigerant pipeline is connected with the at least one refrigerant pipeline of the laser refrigeration device, and is arranged for circulation and cycling of refrigerant.

2. The compression refrigeration fiber laser according to claim 1, wherein the cold plate is a flat planar structure and is a buried pipe cold plate, which has a first cold plate surface on which a semiconductor laser is arranged and a second cold plate surface opposite to the first cold plate surface, the cold plate is vertically arranged on one side in the laser housing, and the second cold plate surface of the cold plate serves as a boundary surface of the first interior space and the second interior space.

3. The compression refrigeration fiber laser according to claim 2, wherein the housing has an upper cabinet plate and a corresponding lower cabinet plate, and four side plates are arranged between the upper cabinet plate and the lower cabinet plate, the four side plates are respectively a first side plate, a second side plate, a third side plate and a fourth side plate that are sequentially connected, the first side plate is opposite to the third side plate, the second side plate is opposite to the fourth side plate, the housing encloses an interior space, and the interior space is divided into the first interior space close to the first side plate and the second interior space close to the third side plate; and the first cold plate surface of the cold plate faces an inner side of the first side plate of the housing, and the second cold plate surface of the cold plate faces the third side plate of the housing.

4. The compression refrigeration fiber laser according to claim 3, wherein a first ventilation hole is arranged on the upper cabinet plate of the housing, a second ventilation hole is arranged on the lower cabinet plate of the housing, a bottom-up air circulation channel is formed between the two ventilation holes, and a first fan group is arranged on a lower side of the upper cabinet plate and/or a second fan group is arranged on an upper side of the lower cabinet plate; wherein rotation directions of fans are set to accelerate air flow from the ventilation holes in a lower portion of the laser housing and then flowing out from the ventilation holes in a upper portion of the laser housing.

5. The compression refrigeration fiber laser according to claim 3, wherein four sides of a periphery of the cold plate are respectively in contact with the upper cabinet plate, the lower cabinet plate, the second side plate and the fourth side plate of the housing, the cold plate and the housing jointly enclose the sealable first interior space, a complete separation surface of the first interior space and the second interior space is formed on the second cold plate surface of the cold plate, such that air flowing between the first ventilation hole and the second ventilation hole does not pass through the first interior space.

6. The compression refrigeration fiber laser according to claim 4, wherein a laser refrigeration device is arranged in the second interior space, a condenser is arranged on an upper side of the second interior space, the condenser comprises a condensation fin device with at least one refrigerant pipeline buried therein, and the condensation fin device is arranged between a compressor device and the first ventilation hole; the first ventilation hole is arranged on the upper side of the second interior space, and the second ventilation hole is arranged on a lower side of the second interior space; and the condensation fin device is arranged on a lower side of the first ventilation hole of the upper cabinet plate, the condensation fin device has multiple gaps between fins, and the multiple gaps form a bottom-up air channel.

7. The compression refrigeration fiber laser according to claim 6, wherein the cold plate is a single-sided buried pipe cold plate or a double-sided buried pipe cold plate, the first ventilation hole is arranged on a portion of the upper cabinet plate corresponding to the second interior space, and the second ventilation hole is arranged on a portion of the lower cabinet plate corresponding to the second interior space; and a first fan group is arranged on a lower side of the first ventilation hole and an upper side of the condensation fin group and/or a second fan group is arranged between a compressor and the second ventilation hole.

8. The compression refrigeration fiber laser according to claim 3, wherein an air-cooled laser comprises a photoelectric interface portion, the photoelectric interface portion comprises a plurality of photoelectric interfaces, and the second side plate of the housing has a photoelectric interface installation area close to the first side plate and a heat dissipation surface area close to the third side plate; the photoelectric interface installation area is arranged for installing at least part or all of the interfaces of the photoelectric interface portion, the photoelectric interface installation area of the second side plate corresponds to a side of the first interior space, the heat dissipation surface area of the second side plate corresponds to a side of the second interior space, and a surface structure for enhancing heat dissipation is arranged in the heat dissipation surface area of the second side plate.

9. The compression refrigeration fiber laser according to claim 8, wherein the photoelectric interface portion is arranged for connection between a main part of the laser and external photoelectricity, comprising a device power input port, a safety lock interface, a control signal input interface and an output optical cable interface, and the photoelectric interface installation area is arranged for installing all interfaces of the photoelectric interface portion.

10. The compression refrigeration fiber laser according to claim 9, further comprising a laser drive portion, a pump laser unit comprises more than one semiconductor laser, and further comprising an N+1 forward and reverse optical fiber combiner, a gain optical fiber portion comprises a ytterbium-doped gain optical fiber and a first grating and a second grating at both ends of the ytterbium-doped gain optical fiber; the N+1 forward and reverse optical fiber combiner is arranged for combining and coupling pump light emitted by the pump laser unit into the gain optical fiber portion, the laser refrigeration device further comprises an electromagnetic four-way reversing valve and a refrigerant liquid storage tank, a frequency conversion compressor is connected with a condenser and at least one cold plate refrigerant pipeline through at least one refrigerant pipeline, refrigerate is arranged in the at least one refrigerant pipeline and the at least one cold plate refrigerant pipeline, the laser refrigeration device further comprises a drying filter, wherein the drying filter is arranged between the condenser and a thermal expansion valve, and wherein an aluminum parallel flow heat exchanger is adopted for the condenser.
